(19) United States
(12) Patent Application Publication
(10) Pub. No.: US 2025/0334709 A1
(43) Pub. Date: Oct. 30, 2025

(54) Seismic Detection System

(71) Applicant: Donald Murphy, Cape Canaveral, FL (US)

(72) Inventor: Donald Murphy, Cape Canaveral, FL (US)

(21) Appl. No.: 18/646,076

(22) Filed: Apr. 25, 2024

(51) Int. Cl. G01V 3/08; G08B 21/10

(52) U.S. Cl. CPC G01V 3/081; G08B 21/10

(57) ABSTRACT

A seismic detection system is provided. The system is comprised of a mobile application that uses an existing magnetometer of a smart device, such as a cell phone, to measure and submit low-frequency electromagnetic field (EMF) emissions to a collection point. This data is then analyzed to create a crowdsourced seismic detection network that delivers real-time, continuous data from multiple users. The collected EMF measurements are used to predict significant geophysical events like earthquakes, volcanic eruptions, and geomagnetic reversals. When such an event is predicted, the application alerts the user through various means such as texts, calls, emails, push notifications, or sounds, providing details about the type and severity of the impending disaster.

### FIELD OF THE INVENTION

The present invention relates generally to the field of natural disaster detection. More specifically, the present invention relates to a seismic detection system that collects data points via a smart device, wherein said data is sent to a central collection point that uses the data to predict natural disasters and warn users of the system. Accordingly, the present disclosure makes specific reference thereto. Nonetheless, it is to be appreciated that aspects of the present invention are also equally applicable to other like applications, devices, and methods of manufacture.

### BACKGROUND

Earthquakes, volcanoes, and other natural disasters can have devastating effects on nearby areas. Further, said disasters are often difficult to identify in advance. As a result, individuals who live near said areas may be unable to adequately prepare for said disasters.

Therefore, there exists a long-felt need in the art for a detection system for natural disasters such as but not limited to earthquakes, volcanoes, and other natural disasters. There also exists a long-felt need in the art for a seismic detection system that allows a user to identify earthquakes, volcanoes, and other natural disasters before they occur. More specifically, there exists a long-felt need in the art for a seismic detection system that allows a user to identify earthquakes, volcanoes, and other natural disasters before they occur wherein the system can notify a plurality of users simultaneously.

The subject matter disclosed and claimed herein, in one embodiment thereof, comprises a seismic detection system. The system is comprised of a mobile application that uses an existing magnetometer of a smart device, such as a cell phone, to measure and submit low-frequency electromagnetic field (EMF) emissions to a collection point. This data is then analyzed to create a crowdsourced seismic detection network that delivers real-time, continuous data from multiple users. The collected EMF measurements are used to predict significant geophysical events like earthquakes, volcanic eruptions, and geomagnetic reversals. When such an event is predicted, the application alerts the user through various means such as texts, calls, emails, push notifications, or sounds, providing details about the type and severity of the impending disaster.

In this manner, the seismic detection system of the present invention accomplishes all the forgoing objectives and provides a detection system for natural disasters such as but not limited to earthquakes, volcanoes, and other natural disasters. More specifically, the device allows a user to identify earthquakes, volcanoes, and other natural disasters before they occur. Further, the system can notify a plurality of users simultaneously.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a seismic detection system. The system is comprised of a mobile application that uses the existing magnetometer of a smart device during use. The application continuously measures low-frequency EMF emissions via the magnetometer and continuously submits said measurements to a virtual collection point.

The collection point then analyzes the data by combining all EMF measurements from all users of the mobile application to form a crowdsourced seismic detection network that provides continuous data in real-time. Using said data, the collection point predicts events such as but not limited to earthquakes, volcanic eruptions, geomagnetic reversal, overhead electromagnetic spikes, etc. If said event is predicted, the application provides a user with an alert. The alert may be in the form of a text, a call, an email, a push notification, an alert, a sound, etc.

Accordingly, the seismic detection system of the present invention is particularly advantageous as it provides a detection system for natural disasters such as but not limited to earthquakes, volcanoes, and other natural disasters. More specifically, the device allows a user to identify earthquakes, volcanoes, and other natural disasters before they occur. Further, the system can notify a plurality of users simultaneously. In this manner, the seismic detection system provides a solution for the early detection of natural disasters.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a graphical view of components of one potential embodiment of a seismic detection system of the present invention in accordance with the disclosed architecture;

FIG. 2 illustrates a graphical view of features of a mobile application of one potential embodiment of a seismic detection system of the present invention in accordance with the disclosed architecture; and

FIG. 3 illustrates a graphical view of features of a collection point of one potential embodiment of a seismic detection system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a detection system for natural disasters such as but not limited to earthquakes, volcanoes, and other natural disasters. There also exists a long-felt need in the art for a seismic detection system that allows a user to identify earthquakes, volcanoes, and other natural disasters before they occur. More specifically, there exists a long-felt need in the art for a seismic detection system that allows a user to identify earthquakes, volcanoes, and other natural disasters before they occur wherein the system can notify a plurality of users simultaneously.

The present invention, in one exemplary embodiment, is comprised of a seismic detection system comprised of a mobile application. The application uses the existing magnetometer of a smart device during use. The application continuously measures low-frequency EMF emissions via the magnetometer and continuously submits said measurements to a virtual collection point.

The collection point then analyzes the data by combining all EMF measurements from all users of the mobile application to form a crowdsourced seismic detection network that provides continuous data in real-time. Using said data, the collection point predicts events such as but not limited to earthquakes, volcanic eruptions, geomagnetic reversal, overhead electromagnetic spikes, etc. If said event is predicted, the application provides a user with an alert. The alert may be in the form of a text, a call, an email, a push notification, an alert, a sound, etc.

Accordingly, the seismic detection system of the present invention is particularly advantageous as it provides a detection system for natural disasters such as but not limited to earthquakes, volcanoes, and other natural disasters. More specifically, the device allows a user to identify earthquakes, volcanoes, and other natural disasters before they occur. Further, the system can notify a plurality of users simultaneously. In this manner, the seismic detection system provides a solution for the early detection of natural disasters.

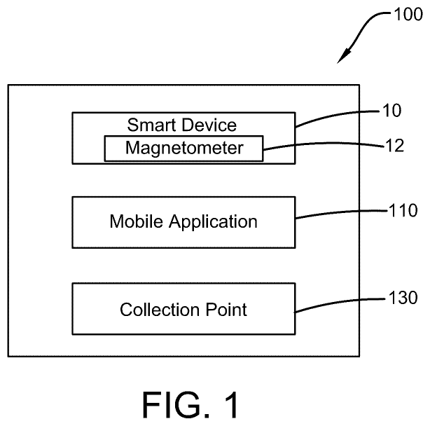

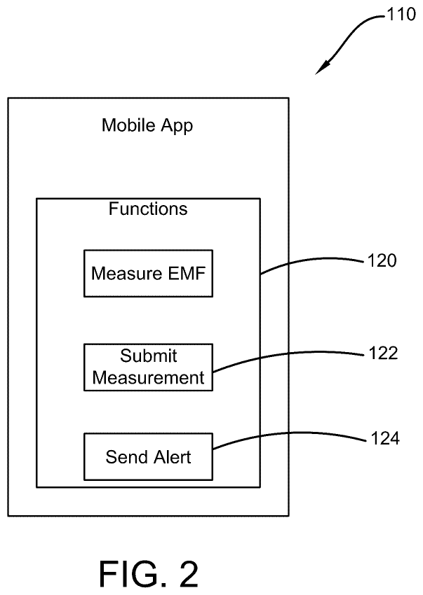

Referring initially to the drawings, FIG. 1 illustrates a graphical view of components of one potential embodiment of a seismic detection system 100 of the present invention in accordance with the disclosed architecture. The system 100 is comprised of a mobile application 110 for a smart device such as but not limited to a cell phone. The application 110 uses the existing magnetometer 12 of the smart device 10 during use. The application 110 has a plurality of functions 120, as seen in FIG. 2. First, the application continuously measures low-frequency EMF emissions 121 via the magnetometer. Then, the application 10 continuously submits said measurements 122 to a virtual collection point 130 such as but not limited to a physical or cloud server. Each measurement preferably includes all three axes of measurement as well as a date and time stamp of each reading.

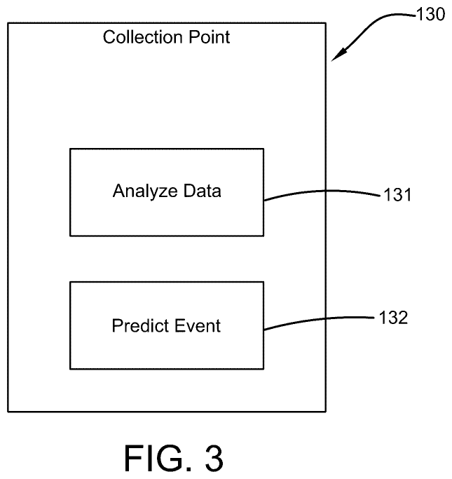

The collection point 130 has a plurality of functions 131,132 as seen in FIG. 3. More specifically, the collection point 130 then analyzes 131 the data. More specifically, the collection point 130 combines all EMF measurements from all users of the mobile application 110 to form a crowdsourced seismic detection network that provides continuous data in real-time. Using said data, the collection point 130 predicts 132 events such as but not limited to earthquakes, volcanic eruptions, geomagnetic reversal, overhead electromagnetic spikes, etc. If said event is predicted, the application 110 provides a user with an alert 124. The alert 124 may be in the form of a text, a call, an email, a push notification, an alert, a sound, etc. that indicates the type of disaster and also potentially the severity/magnitude of the disaster.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “seismic detection system” and “system” are interchangeable and refer to the seismic detection system 100 of the present invention.

Notwithstanding the forgoing, the seismic detection system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the seismic detection system 100 as shown in the FIGS. are for illustrative purposes only, and that many other sizes and shapes of the seismic detection system 100 are well within the scope of the present disclosure. Although the dimensions of the seismic detection system 100 are important design parameters for user convenience, the seismic detection system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A seismic detection system comprising:
a smart device comprised of a magnetometer;
a mobile application; and
a collection point.

2. The seismic detection system of claim 1, wherein the mobile application measures a low-frequency EMF emission.

3. The seismic detection system of claim 2, wherein the low-frequency EMF emission is measured by the magnetometer.

4. The seismic detection system of claim 2, wherein the low-frequency EMF emission is sent to the collection point.

5. The seismic detection system of claim 1, wherein the collection point is comprised of a physical server.

6. The seismic detection system of claim 4, wherein the collection point uses the low-frequency EMF emission to predict a disaster.

7. The seismic detection system of claim 6, wherein the disaster is comprised of an earthquake, a volcanic eruption, a geomagnetic reversal, or an overhead electromagnetic spike.

8. The seismic detection system of claim 7, wherein the once the disaster is predicated, the mobile application provides an alert.

9. The seismic detection system of claim 8, wherein the alert is comprised of a text, a call, an email, a push notification, an alert, or a sound.

10. A seismic detection system comprising:
a smart device comprised of a magnetometer;
a mobile application; and
a collection point comprised of a cloud server.

11. The seismic detection system of claim 10, wherein the mobile application measures a low-frequency EMF emission.

12. The seismic detection system of claim 11, wherein the low-frequency EMF emission is measured by the magnetometer.

13. The seismic detection system of claim 11, wherein the low-frequency EMF emission is sent to the collection point.

14. The seismic detection system of claim 10, wherein the collection point is comprised of a physical server.

15. The seismic detection system of claim 13, wherein the collection point uses the low-frequency EMF emission to predict a disaster.

16. The seismic detection system of claim 15, wherein the disaster is comprised of an earthquake, a volcanic eruption, a geomagnetic reversal, or an overhead electromagnetic spike.

17. The seismic detection system of claim 15, wherein the once the disaster is predicated, the mobile application provides an alert.

18. The seismic detection system of claim 10, wherein the alert is comprised of a text, a call, an email, a push notification, an alert, or a sound.

19. The seismic detection system of claim 12, wherein the magnetometer records a date and time stamp.

20. The seismic detection system of claim 12, wherein the magnetometer records a first axis, a second axis, and a third axis of the low-frequency EMF emission.
